(19) United States
(12) Patent Application Publication
(10) Pub. No.: US 2025/0114960 A1
(43) Pub. Date: Apr. 10, 2025

(54) A CUTTING ASSEMBLY, A KNIFE FOR THE CUTTING ASSEMBLY, A COUNTER DEVICE FOR THE CUTTING ASSEMBLY, AND A METHOD OF SLICING FOOD WITH THE CUTTING ASSEMBLY

(71) Applicant: MAREL A/S, Arhus N (DK)

(72) Inventors: Michael TJORNELUND, Arhus N (DK); Niels Bjarne HUNDTOFTE, Arhus N (DK)

(21) Appl. No.: 18/729,971

(22) PCT Filed: Feb. 9, 2023
(86) PCT No.: PCT/EP2023/053242

§ 371 Date: Jul. 18, 2024

(30) Foreign Application Priority Data
Feb. 11, 2022 (EP) 22156392.7

(51) Int. Cl. B26D 1/00; B26D 1/16; B26D 7/00

(52) U.S. Cl. CPC B26D 1/0006; B26D 1/16; B26D 7/0006; B26D 2001/0053; B26D 2210/02

(57) ABSTRACT

A cutting assembly for cutting thin slices of non-rigid food objects, includes a circular knife, a counter-structure with a counter-hold, and a movement-structure configured for moving the knife in a cutting-plane relative to the counter-structure with the frontside facing the counter-hold such that a point at which the knife contacts the counter-hold moves along the counter-hold from an enter-point to an exit-point while the food object is cut between the counter-hold and the knife. The knife has a rim frontside defining a cutting angle to the centre axis and a centre backside defining at least one eject angle to the centre axis, the eject angle is smaller than the cutting angle, and the counter-hold is movable relative to the counter-structure such that the counter-hold moves in a direction away from the knife during movement of the knife in the cutting-plane.

### INTRODUCTION

The disclosure relates to a cutting assembly for cutting thin slices of non-rigid food objects such as fish, meat, fruit, and similar food objects, e.g. in a surface-frozen state or in a non-frozen state. The disclosure further relates to a knife and a counter device for such a cutting assembly, and a method of cutting slices of food objects by use of the assembly.

### BACKGROUND

Portioning and slicing are widely automated in the food industry. Different kinds of knifes operate at very high speed to slice food objects while the food objects are conveyed on a conveyor. Speed, quality, visual appearance, and precise thickness of the slices are important factors in reducing processing costs and increasing the value of the product.

When cutting non-rigid, slippery, or sticky products, the quality of the cutting may be reduced due to adhering of the slices to the surface of the knife. The slices may therefore need to have a minimum thickness, and they may not always be deposited nicely and ready for packing. Costly and potentially manual post processing may therefore be required, and the slices may become thicker than desired.

### SUMMARY

It is an object to enable faster slicing of food objects into pre-determined thickness including thin slices and to enable an implicit nice and well-ordered arrangement of the slices to alleviate the transporting and/or packaging process and thereby make post handling unnecessary or at least less critical. It is also an object to enable slicing food objects to reduce or avoid frayed edges, i.e. food structures being present on the slices due poor cutting of a side of the food object facing a transporting surface.

Due to the combination between a counter-hold and the specific structure of the knife, particularly the sections of different angles, the cutting speed may be high, and the thickness of the slices can be pre-selected such as be very thin e.g., 2-10 mm. Furthermore, it enables a very precise, straight cut and reduces the risk of frayed edges of the sliced food objects.

The counter-hold is movable relative to the counter-structure such that the counter-hold moves in a direction away from the knife during movement of the knife in the cutting-plane.

Particularly, the counter-hold may be moved by the knife when the knife touches the counter-hold at the area between the enter-point and the exit point, i.e. in the area where there is direct contact between the knife and the counter-hold.

The movability, and particularly the ability of the knife to move the counter-hold provides a more constant contact between the counter-hold and the knife in the zone between the enter-point and the exit-point. In this zone, the knife can be constantly or permanently in contact with the counter-hold. The disclosure may be seen as particularly, but not exclusively, advantageous for obtaining a cutting apparatus enabling that the cutting, such as slicing, results in (thin) slices, such as cut of sub-cuts, with thicknesses in the millimetre range, such as 10 mm or less, such as 5 mm or less, such as 3 mm or less.

More particularly, by the movability of the counter-structure, the knife and the counter-hold provide an improved scissor-effect where an efficient cutting of the food object may be carried out. This may be advantageous if the food object comprises structures, which are not easily cut, such as tendons. Another possible advantage may be that the physical contact between the counter-hold and the knife may prevent the knife from becoming blunt. Further, due to the movability of the counter-structure, the contact between the counter-structure and the knife may be improved which again helps keeping the knife clean by a scraping effect.

The cutting apparatus may be arranged for carrying out 60 or more, such as 100 or more, such as 120 or more, such as 180 or more, such as 200 or more, cuts per minute.

The ‘food object’ may be fish or meat, such as meat, such as meat from cattle or pig, such as a primal cut from cattle or pig. The ‘food object’ may be a fresh food object, such as non-frozen and/or non-undercooled. The food object may have a mass of at least 100 grams, such as at least 1000 g and/or a mass of less than 10 kg, such as less than 5 kg. The food object may have a mass within 0.1-10 kg, such as within 1-5 kg.

When specifying, herein, an angle of a surface of the knife, e.g., the cutting angle, or the eject angle, it is the angle of a radially extending tangent to the surface. Since the surface may be curved or stepwise change angle to the centre axis, the angle is a tangent at a specific point. That is the reason for specifying that the centre backside defines “in at least one portion, an eject angle” since the centre backside may define different angles for different portions of the centre backside.

Particularly, the fact that the eject angle is smaller than the cutting angle, enables the rim frontside to move very close to and to touch the counter-hold and enables the centre backside to eject the slices away from the backside of the knife. This enables a well-ordered laying of slices when they are cut from the food object.

The eject angle is considered as an angle somewhere at the centre backside. The centre backside may define at least one eject angle to the centre axis. This means that the centre backside may be curved, or it may stepwise define different angles to the centre axis. However, at one point on the centre backside, the angle forms what is referred to herein as an “eject angle’, and this is smaller than the cutting angle. I.e. the eject angle is an angle at a portion of the centre backside or the angle of the entire centre backside.

The rim backside may have a radial dimension of less than 10 pct. e.g., less than 1 pct. of the radial dimension from the centre axis to the sharp edge. The rest of the backside is defined by the centre backside.

The knife may contact the counter-hold in a contact point which may be a point on the rim frontside, and the counter-hold may have a surface which is substantially perpendicular to the centre axis, such as within 88°-90°, or 89.5°-90°.

The centre backside may comprise a plurality of grooves extending radially relative to the centre axis. The grooves enable delivery of the slices in a styled fashion, e.g., ready to be packed.

The grooves may particularly have a shape enabling the grooves to produce a flow of air directed both along the backside and away from the backside of the knife when the knife rotates about the centre axis. This air flow may increase ejection of the slices of the food object and thereby further facilitate a well-ordered laying of the slices.

The centre backside may comprise a centre backside portion and an intermediate backside portion.

The intermediate backside portion extends radially between the centre backside portion and the rim backside, and the centre backside portion and the intermediate backside portions define different angles to the centre axis. Herein we refer to these angles as the first angle between the centre backside portion and the centre axis and the second angle between the intermediate backside portion and the centre axis.

If the second angle is smaller than the first angle, it may be ensured that the ejection of the slices of food items takes place at the intermediate backside portion—i.e. near the periphery, i.e. near the cutting edge of the knife. At this location, the peripheral speed is nearly the same as the speed of the cutting edge, and that will further facilitate a well-ordered ejection of the slices.

The intermediate backside portion may e.g., have a radial dimension in the order of up to 50 pct. of a radial distance from the centre axis to the cutting edge.

The grooves may be made exclusively in the intermediate backside portion. Again, this is a portion where the speed is high since it is close to the peripheral edge, and that provides good background for establishing an airflow by use of the grooves and thereby eject the slices.

The frontside of the knifes which faces towards the counter-hold may be smooth without grooves. This reduces air flow in the upstream direction against the flow direction of the food objects which are to become sliced. Such a flow against the outfeed direction may be undesired. Particularly, the rim frontside may be smooth without any surface texture.

The rim backside may also be smooth without any grooves or similar surface texture. The rim backside may have an angle to the centre axis which is smaller than the angle at any place of the centre backside.

The sharp edge may particularly be smooth without teeth, and it may thus form a circular shape with the centre axis as the centre of the circle.

By definition herein, each groove in the centre backside may have a length in the radial direction and a width perpendicular to the radial direction, wherein the grooves are separated by a plateau defining a distance between the grooves exceeding the width.

The counter-hold may be movable relative to the counter-structure by rotation around a rotation axis.

When viewed in a projection onto a plane perpendicular to the centre axis, and when following the path of the knife from the enter point to the exit point, then a part of the knife may pass the rotation axis of the counter-hold before it reaches the enter-point where it makes contact with the counter-hold, or alternatively, it may pass the rotation axis of the counter-hold simultaneously with making contact with the counter-hold. This makes rotation of the counter-hold about the rotation axis easier and reduces the impact of the counter-hold on the knife and thereby potentially protects the knife and the counter-hold.

The counter-hold may particularly be moved by the knife when the knife moves from the enter-point to the exit-point, i.e. the counter-hold swings around the rotation axis by contact with the knife during movement of the knife in the cutting-plane.

The counter-hold may be movable from a forward position to a recessed position against force from a spring structure arranged to move the counter-hold to the forward position when there is no contact between the knife and the counter-hold.

The spring structure may be a spring element or an element of an elastically deformable material, e.g., elastically deformable rubber element, or a spring, such as a coiled spring.

The motor may be configured to rotate the knife at a speed by which the grooves create an air flow having a component in the direction of the centre axis, i.e. blowing away from the backside of the knife and thereby facilitating ejection of the slices from the knife.

The movement-structure moves the knife in the cutting-plane and therefore defines the cutting-plane.

Prior to cutting, the counter-hold intersects the cutting surface, and during cutting, the counter-hold is pushed at least partially out of the cutting surface by the knife.

This may be advantageous for ensuring that the at least one knife comes into contact with the counter-hold and that there is contact between the counter-hold and the knife during cutting.

The movement-structure may comprise a connecting structure connecting the at least one knife to a motor. The motor is arranged to rotate the connecting structure about a shearing axis whereby the at least one knife orbits around the shearing axis and passes the counter-hold during its orbiting movement.

The connecting structure may hold a pair of two knifes in a rotatably exchangeable fashion such that the two knifes alternatingly interact with the counter-hold. This may be provided when the two knives are located on opposite sides of the shearing axis—i.e. the connecting structure holds one knife on one side of the shearing axis and holds the other knife on the other side of the shearing axis.

In a second aspect, the disclosure provides a circular knife for cutting food objects during rotation about a centre axis. The knife has a frontside and a backside and extends radially from a centre section to a rim section.

The centre section forms a centre backside and a centre frontside and the rim section forms a rim backside and a rim frontside and terminates radially in a circular sharp edge.

The rim frontside defines a cutting angle to the centre axis and the centre backside defines at least one eject angle to the centre axis. This eject angle is smaller than the cutting angle and the knife therefore facilitates movement with the rim frontside close to a counter-hold while ejecting the slices nicely by use of the centre backside.

The centre backside may comprise a plurality of grooves extending radially relative to the centre axis, and these grooves are particularly arranged close to the rim backside, i.e. in what is referred to herein as the intermediate backside portion.

The rim backside may have a radial dimension of less than 10 pct. e.g., less than 1 pct. of the radial dimension from the centre axis to the sharp edge. The rest of the backside is defined by the centre backside.

The centre backside portion may define a first angle to the centre axis and the intermediate backside portion may define a second angle to the centre axis, the second angle being smaller than the first angle.

The grooves may exclusively be formed in the intermediate backside portion, and they may be shaped to create an air flow having a component in the direction of the centre axis upon rotation of the knife about the centre axis.

The grooves may have a semi-circular or V-shaped cross-section.

In a third aspect, the disclosure provides a counter device comprising a counter-hold movable relative to a counter-structure around a rotation axis such that the counter-hold moves against the force of an elastically deformable spring structure. Such a device may operate well together with the knife of the second aspect and be suitable in an assembly according the first aspect of the disclosure.

The counter-hold may be V-shaped to match a V-shape of a conveyor belt feeding food objects to a slicing process. The counter-hold may alternatively be linear to match a linear shape of a conveyor belt feeding food objects to a slicing process.

In a fourth aspect, the disclosure provides a method of cutting slices of a pre-determined thickness of a food product, such as thin slices of a food product, where the food product may be rigid or non-rigid food objects. The method including the use of the cutting assembly according to the first aspect. The food product may e.g., be non-frozen, frozen, or surface frozen.

The method comprises rotating the knife about the centre axis while moving the knife in the cutting-plane to thereby move a point where the knife contacts the counter-hold to cut a slice from the food object. The method may include simultaneously using the grooves to create an air flow having a component in the direction of the centre axis.

Since the cutting occurs in a scissor like way, i.e., while the point of contact moves along the counter-hold, the food objects may be cut nicely without fraying.

The cutting assembly may comprise an outfeed conveyor defining an outfeed direction in which direction the slices of food objects are transported away from the knife. The component of the air flow being in the direction of the centre axis may particularly be directed in the outfeed direction. This enables the food objects to be separated from the knife and moved in the outfeed direction by use of air generated by the grooves in the knife.

Any feature specifically mentioned relative to one of the first, second, third, and fourth aspect of the disclosure may also apply to the other of the first, second, third, and fourth aspect of the disclosure.

### BRIEF DESCRIPTION OF THE DRAWINGS

FIGS. 1a and 1b illustrate a cutting assembly for cutting food objects;

FIG. 2 illustrates the cutting assembly in a different position of the knife relative to the counter-hold;

FIGS. 3 and 4 illustrate frontside and backside of a circular knife in the cutting assembly;

FIGS. 5a, 5b illustrate a cross section through the knife; and

FIGS. 6a, 6b, and 7 illustrate cross-sections through the grooves and dimensions of the grooves;

FIG. 8 illustrates the assembly seen from the direction where the food objects enter;

FIG. 9 illustrates details of the counter device;

FIG. 10 illustrates details of the inlet conveyor and counter-hold; and

FIG. 11 illustrates details of the rotation axis 91 and the enter-point 16.

### DETAILED DESCRIPTION OF THE DRAWINGS

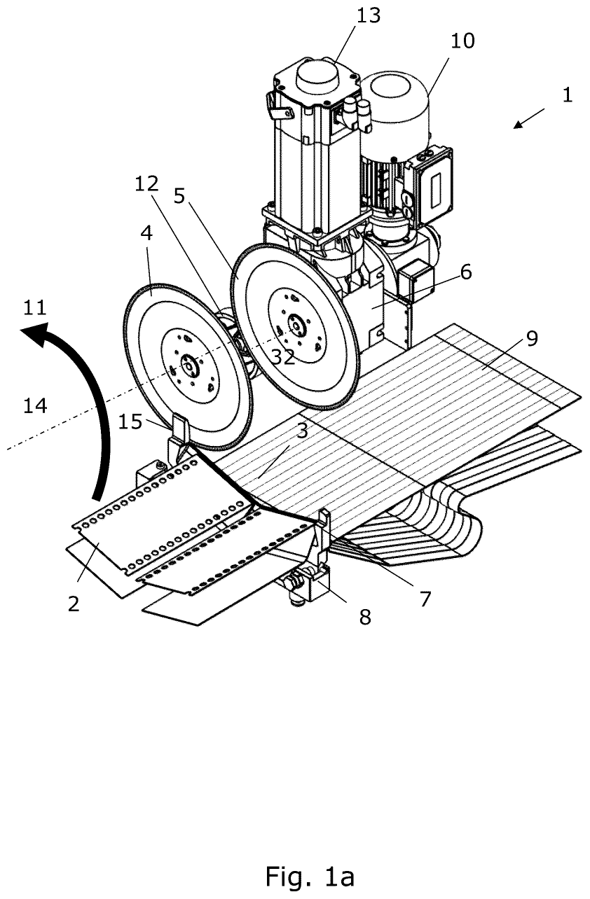

FIG. 1a illustrates a cutting assembly 1 made for cutting slices of food objects, such as thin slices of non-rigid food objects, e.g., thin slices of ham, cheese, or non-frozen meat etc. The cutting assembly defines an inlet for receiving the food object on an inlet conveyor 2 by which the food object is moved to the cutting position 3. The inlet conveyor 2 comprises first and second conveyor belts arranged in a V-shape to support the food object and reduce sideways sliding.

At the cutting position, slices are cut from the food object by use of the circular knifes 4, 5. The circular knife is suspended in a movement-structure, in this case exemplified by a motor 13, a connecting structure 12, and a gear 6 connecting the connecting structure 12 to the motor 13. The connecting structure 12 holds a pair of knifes in a rotatably exchangeable fashion such that the knifes 4 and 5 alternatingly interact with the counter-hold 7 of a counter-structure 8 to cut slices of the food objects. In other embodiments, a single knife may be used, and the knife may be moved in the cutting plane in other ways.

During this procedure, a first of the two knifes interchangeably approach an enter-point of the counter-hold and moves along the counter-hold such that a point of contact moves to the other end of the counter-hold, referred to herein as exit-point. For this to happen, the knives may be moved in a cutting-plane perpendicular to the inlet conveyor or inlet conveyors and the counter-hold may define an angle to the inlet conveyor or inlet conveyors.

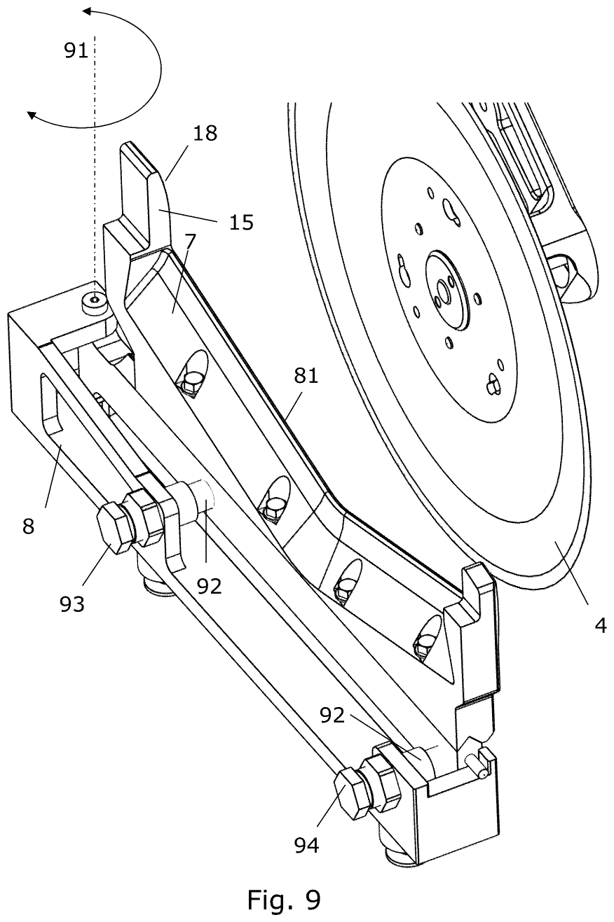

When seen in a cross-section perpendicular to the cutting-plane, the counter-hold extends at an angle in the range of 0.1-5 degrees to the knife such as 0.2-1 degrees. This angle is referred to herein as the counter-hold angle, and it is illustrated and explained relative to FIG. 9.

The cutting-plane is perpendicular to the conveying direction, and the counter-hold is e.g., at an angle of 0.6 degrees to the conveying direction.

The cut slices may be positioned in a styled fashion on the outfeed conveyor 9 such as in batches ready for packing in an aesthetic and customer appealing layout. The outfeed conveyor defines an outfeed direction in which the cut slices are transported. If the knife comprises grooves on the backside of the knife, the grooves can create an airflow in the outfeed direction and the grooves may therefore facilitate the styled positioning of the cut slices.

The knifes 4, 5 each rotate individually by the motor 10 about the individual centre axes 32 and they are movable in the cutting-plane indicated by the arrow 11. This movement in the cutting-plane is made by rotating the mutual connecting structure 12, which carries both knifes 4, 5, by the motor 13, around the shearing axis 14. This may create an orbital rotation of the knifes around the shearing axis 14. Each knife rotates around their individual centre axes 32, e.g. in an opposite direction of the orbital rotation.

FIG. 1b illustrates details of the interaction between the knife 4 and the counter-hold 7. In FIGS. 1a and 1b, the knife is at the enter-point, and it has contacted an interface stub 15 of the counter-hold. The interface stub 15 forms an inclined upper surface 18 ensuring a smooth entrance of the knife. From this enter-point, the point of contact between the knife and the counter-hold moves along the counter-hold until the knife leaves at an exit-point. This occurs in response to the movement of the knife in the cutting-plane, it is a result of said angle between the cutting-plane and the counter-hold, and it is a result of the counter-hold being movable by rotation about a rotation axis 91.

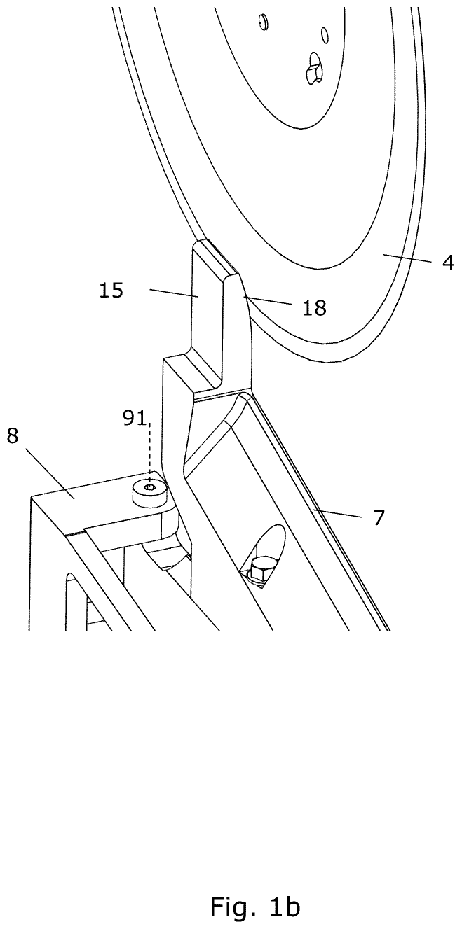

In FIGS. 1a and 1b, the knife 4 is entering into the cutting position and in FIG. 2, the knife 5 is exiting the counter-hold. During movement of the knife in the cutting-plane, the frontside of the knife faces the counter-hold 7 in a specific point of contact. The counter-hold is arranged at an angle to the knife and the point of contact therefore moves along the counter-hold from the enter-point 16 to the exit point 17 while the knife is moved in the cutting-plane.

FIGS. 1a, 1b, and 2 illustrate the device from the frontside of the knives.

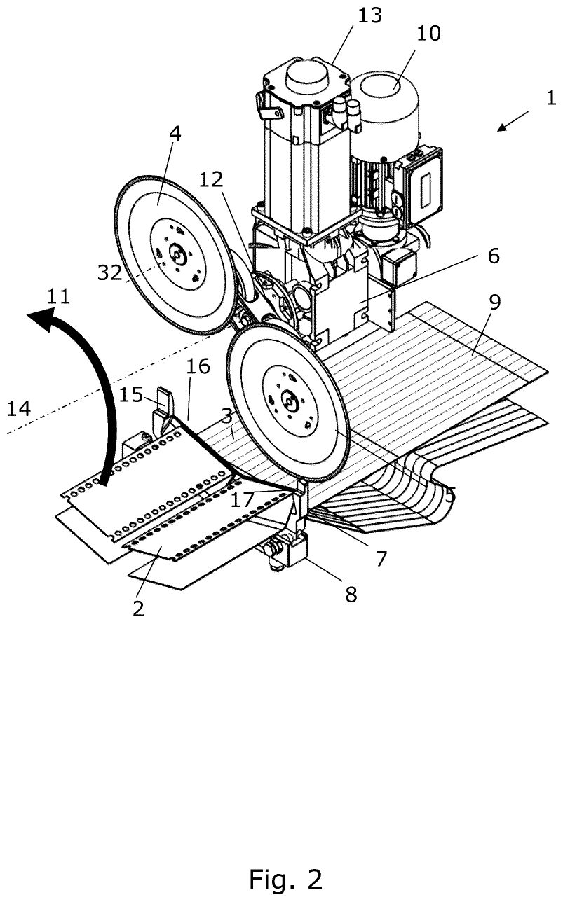

The knife is shown in FIG. 3. It comprises a centre hole 30 for mounting in the movement-structure 6 and further comprises interface openings 31 engaging the movement-structure 6 and being used for rotating the knife about the centre axis illustrated by the dotted line 32.

The knife extends radially as illustrated by the arrow 33 from the centre to a circular sharp edge 34. FIG. 3 illustrates a frontside of the knife and FIG. 4 illustrates an opposite backside of the knife.

The frontside defines a centre frontside 35, 36, an eject section 36, and a rim frontside 37. The backside correspondingly defines a centre backside, and a rim backside 43. The backside comprises a plurality of grooves 44 extending radially relative to the centre axis.

The centre backside comprises a centre backside portion 41 and an intermediate backside portion 42.

The intermediate backside portion 42 is located between the centre backside portion 41 and the rim backside 43.

The centre backside portion 41 defines a first angle 53 to the centre axis 32 and the intermediate backside portion 42 defines a second angle 54 to the centre axis 32. The second angle is smaller than the first angle and is suitable for ejecting the slices of the food object in an ordered way. In this embodiment, the eject angle is constituted by the second angle 54.

In the embodiment illustrated in FIG. 4, the grooves 44 are exclusively formed in the intermediate backside portion 42 and the centre backside portion 41 has a smooth surface without grooves.

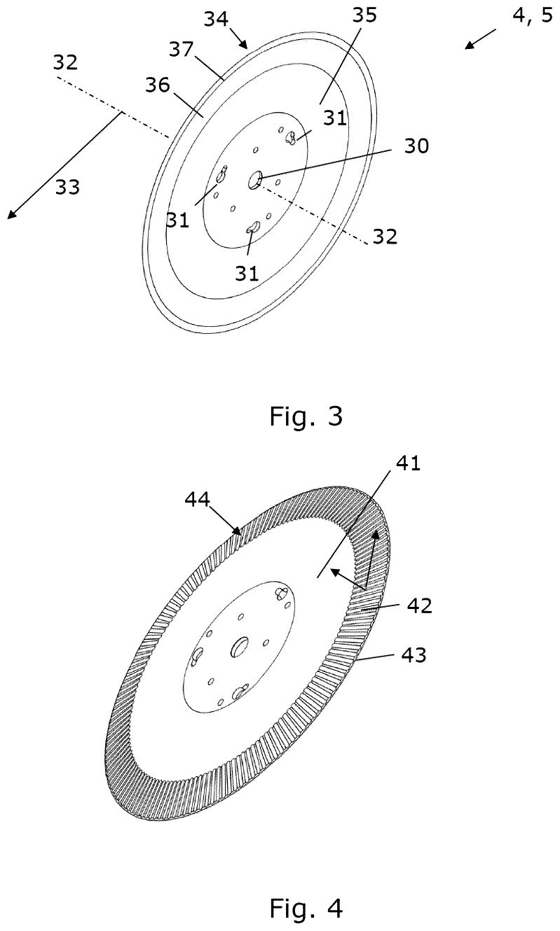

FIGS. 5a and 5b illustrate a cross section through the knife and illustrate the mentioned angles.

In FIG. 5b, the cross section is enlarged to illustrate details of the rim portion. For illustrative purpose, dotted lines are added to indicate the different angles. The dotted line 51 defines the direction of the centre axis 32. The dotted line 55 illustrates a tangent to the centre backside portion, and the dotted line 56 illustrates a tangent to the intermediate backside portion, and the dotted line 57 illustrates a tangent to the rim frontside.

FIG. 5b illustrates that the rim frontside 37 defines the cutting angle 52 to the centre axis 32, and the centre backside defines two different angles to the centre axis 32, namely the angles 53 and 54.

Herein, reference is made to the angle between the centre backside portion 41 and the centre axis 32 as the first angle 53, and the angle between the intermediate backside portion 42 and the centre axis 32 as the second angle 54.

The first angle 53 is smaller than the cutting angle 52 and the second angle 54 is smaller than the first angle 53. The first angle may e.g., be 75-87 degrees, the second angle may be 65-80 degrees, and the cutting angle may be above 87 degrees, e.g., 90 degrees as indicated in the drawing.

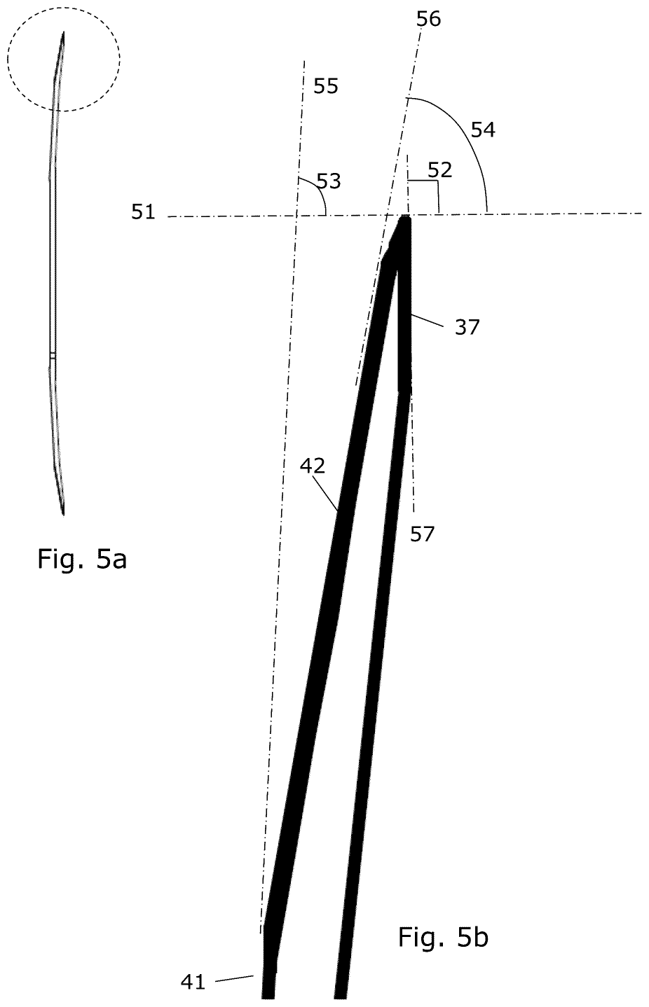

FIG. 6a illustrates a cross section through the grooves 44. The grooves each forms a simi-circular cross section which defines an airflow with a component 61 directed away from the backside of the knife when the knife is rotated about the centre axis 32. Rotation causes the grooves to move in the direction indicated by the arrow 62. Each groove 44 is separated by a plateau 63 from adjacent grooves.

FIG. 6b illustrates dimensions of the grooves in a specific embodiment. In this embodiment, the plateau is 4.28 mm, and the grooves are 2.65 mm. In other embodiments, the plateau is less than 3 mm. such as 2.95, or 2.9 mm, and the grooves are more than 3 mm, such as 3.5, or 4 mm. The length of the grooves may e.g., be above 25 mm, above 30 mm or above 35. The length may constitute e.g., 10-40 pct. of the radial dimension of the knife from the rotation axis 32 to the sharp edge 34

FIG. 7 illustrates an alternative cross section which likewise creates an airflow with a component 61 directed away from the backside of the knife when the knife is rotated about the centre axis 32. Rotation causes the grooves to move in the direction indicated by the arrow 62.

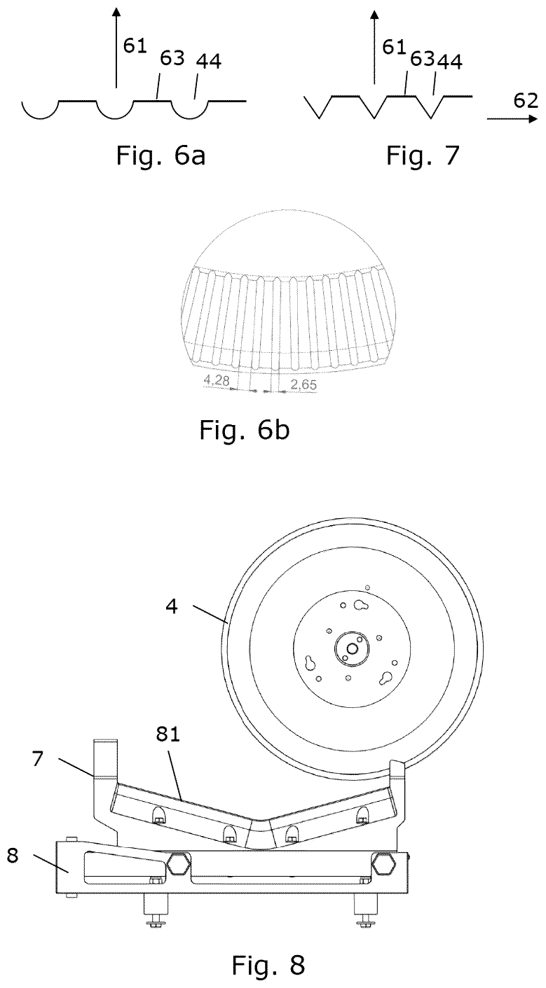

FIG. 8 illustrates the knife and the counter device for the cutting assembly seen from the end where the food objects arrive. In this view, it is clearly seen that the counter-hold is V-shaped to match said V-shape of the inlet conveyor.

The upper edge 81 of the counter-hold may follow the shape of the V-shaped conveyor, and it may particularly be offset 1-5 mm. in a vertical direction relative to an upper surface of the conveyor such that the food objects can move unhindered from the conveyor across the counter-hold.

FIG. 9 illustrates further details of the counter-hold device comprises a counter-hold 7 movable relative to the counter-structure 8 around a rotation axis illustrated by the dotted line 91. Two elastically deformable rubber elements form spring structures 92 arranged to move the counter-hold towards a forward position. When the knife 4 moves from the enter-point to the exit-point, it will press the counter-hold 7 backwards relative to the counter-structure 8 against the force from the spring structures 92. Due to this coordinated movement of the knife 4 and the counter-hold 7, the contact point between the knife and the counter-hold moves along the counter-hold during the cutting of the food object. The cutting angle 52 of the rim frontside 37 enables a close contact between the knife and the counter-hold and facilitates nice and thin slices of the food objects.

The rotation axis 91 extends vertically relative to normal operation. This could typically be perpendicular to the centre axis 32 of the knifes.

The counter-hold is not elastically deformable. On the contrary, it is made from a rigid material such as Polyoxymethylene (POM), duplex, or similar hard plastic types, or it could be made of metal, such as a self-lubricating metal, such as bronze. This allows the counter-hold to move by rotation about the rotation axis while the counter-hold is non-deformed. Since it preserves its shape, the contact with the knife becomes more predictable and the slicing may improve.

The angle of the counter-hold relative to the counter-structure can be adjusted by the adjustment screws 93, 94.

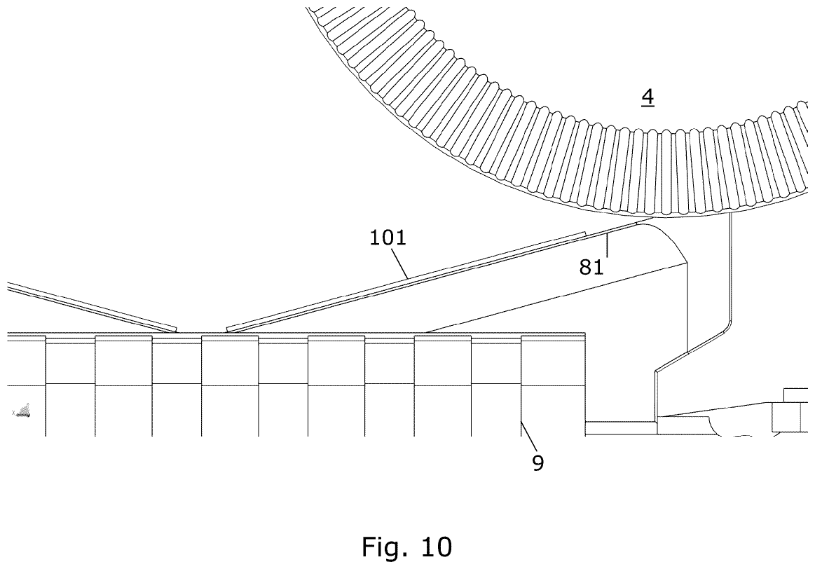

FIG. 10 illustrates the counter-hold from a direction upstream, i.e., against the direction in which the food objects are conveyed to the cutting position 3. The cutting assembly comprises a V-shaped inlet conveyor 2 having an upper surface 101 on which the food items are conveyed. This upper surface is above the counter-hold 7 such that the upper edge 81 of the counter-hold 7 is below the V-shaped conveying surface. This allows the food objects to be conveyed over the counter-hold. Illustrated is also a linear surface of an outfeed conveyor 9.

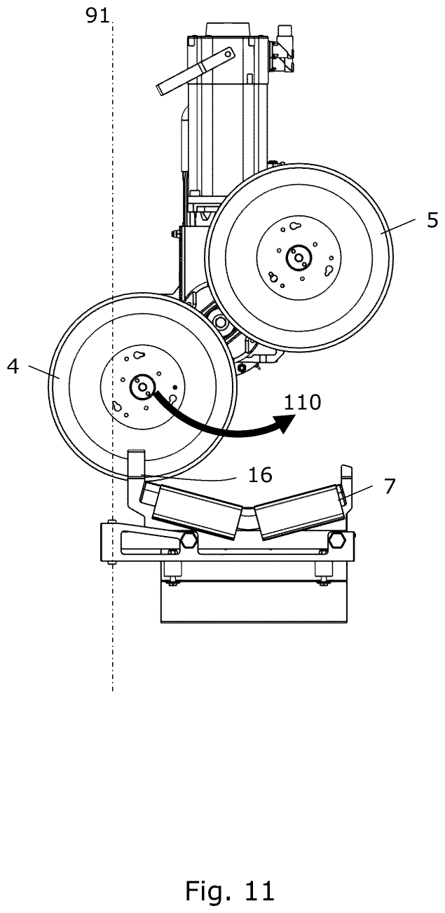

FIG. 11 illustrates the counter-hold and knifes 4, 5 seen in the direction of the centre axes 32. This corresponds to a projection onto a plane perpendicular to the centre axes 32. In the illustrated moment, knife 4 has just reached the enter-point 16 where it contacts the counter-hold 7. It is seen that the enter-point 16 is arranged relative to the rotation axis 91 such that the knife, during movement in the cutting-plane, passes the rotation axis 91 before it passes the enter-point 16. The movement in the cutting-plane is illustrated by arrow 110. The fact that the knife touches the counter-hold after it has passed the rotation axis 91 provides an easier deflection of the counter-hold 7 away from the knife.

1.-32. (canceled)

33. A cutting assembly for cutting food objects, the cutting assembly comprising:
at least one circular knife having a frontside and a backside and extending radially from a centre section to a rim section, the centre section forming a centre backside and a centre frontside and the rim section forming a rim backside and a rim frontside and terminating radially in a circular sharp edge,
a motor arranged to rotate the knife around a centre axis extending through the centre section,
a counter-structure with a counter-hold, and
a movement-structure configured for moving the knife in a cutting-plane relative to the counter-hold with the frontside facing the counter-hold such that a point at which the knife contacts the counter-hold moves along the counter-hold from an enter-point to an exit-point while the food object is cut,
wherein the rim frontside defines a cutting angle to the centre axis and the centre backside defines, in at least one portion, an eject angle to the centre axis, the eject angle being smaller than the cutting angle, and
wherein the counter-hold is movable relative to the counter-structure such that the counter-hold moves in a direction away from the knife during movement of the knife in the cutting-plane.

34. The cutting assembly according to claim 33, wherein a contact point at which the knife contacts the counter-hold is a point on the rim frontside, said contact point moving along the counter-hold and along the rim frontside during cutting.

35. The cutting assembly according to claim 33, wherein the centre backside comprises a plurality of grooves extending radially relative to the centre axis.

36. The cutting assembly according to claim 33, wherein the centre backside comprises a centre backside portion and an intermediate backside portion, the intermediate backside portion extending radially between the centre backside portion and the rim backside,
wherein the centre backside portion defines a first angle to the centre axis and the intermediate backside portion defines a second angle to the centre axis, the second angle being smaller than the first angle.

37. The cutting assembly according to claim 35, wherein the grooves are exclusively formed in the intermediate backside portion.

38. The cutting assembly according to claim 33, wherein the frontside is smooth without grooves.

39. The cutting assembly according to claim 33, wherein the sharp edge is smooth without teeth.

40. The cutting assembly according to claim 33, wherein each groove has a length in the radial direction and a width perpendicular to the radial direction,
wherein the grooves are separated by a plateau defining a distance between the grooves exceeding the width.

41. The cutting assembly according to claim 33, wherein the counter-hold is movable by rotation relative to the counter-structure around a rotation axis such that the counter-hold moves in the direction of the centre axis away from the knife during movement of the knife in the cutting-plane.

42. The cutting assembly according to claim 41, wherein the enter-point is arranged relative to the rotation axis such that a part of the knife during movement in the cutting-plane passes the rotation axis at the latest simultaneously with passing the enter-point.

43. The cutting assembly according to claim 41, wherein the counter-hold is movable by contact with the knife during movement of the knife in the cutting-plane.

44. The cutting assembly according to claim 41, wherein the counter-hold is movable from a forward position to a recessed position against force from a spring structure arranged to move the counter-hold to the forward position when there is no contact between the knife and the counter-hold.

45. The cutting assembly according to claim 44, wherein the spring structure is a spring or an element of an elastically deformable material.

46. The cutting assembly according to claim 41, wherein the rotation axis extends at an angle of 80-100 degrees to the centre axis.

47. The cutting assembly according to claim 35, wherein the motor is configured to rotate the knife at a speed by which the grooves create an air flow having a component in the direction of the centre axis.

48. The cutting assembly according to claim 33, comprising a conveyor arrangement from an inlet to the counter-hold, the conveyor arrangement forming a V-shaped conveying surface for transporting food objects, and the counter-hold having a matching V-shape.

49. The cutting assembly according to claim 33, comprising a conveyor arrangement from an inlet to the counter-hold, the conveyor arrangement forming a plane conveying surface for transporting food objects, and the counter-hold having a matching linear-shape.

50. A circular knife for cutting food objects during rotation about a centre axis, the knife having a frontside and a backside and extending radially from a centre section to a rim section, the centre section forming a centre backside and a centre frontside and the rim section forming a rim backside and a rim frontside and terminating radially in a circular sharp edge,
wherein the rim frontside defines a cutting angle to the centre axis and the centre backside defines at least one eject angle to the centre axis, the eject angle being smaller than the cutting angle and
wherein the centre backside comprises a plurality of grooves extending radially relative to the centre axis.

51. The circular knife according to claim 50, wherein the grooves are exclusively formed in the intermediate backside portion.

52. A counter device for a cutting assembly, the counter device comprises a counter-hold movable relative to a counter-structure around a rotation axis such that the counter-hold moves against the force of an elastically deformable spring structure.

53. A method of cutting slices of food objects by use of the cutting assembly according to claim 35 comprising rotating the knife about the centre axis while moving the knife in the cutting-plane to thereby move a point where the knife contacts the counter-hold during cutting, and simultaneously using the grooves to create an air flow having a component in the direction of the centre axis.
